(19) United States
(12) Patent Application Publication
(10) Pub. No.: US 2004/0001087 A1
(43) Pub. Date: Jan. 1, 2004

(54) Methods and apparatus for electronic distribution of customized content via a broadcast signal

(76) Inventors: James L. Warmus, LaGrange, IL (US); Mark G. Dreyer, Aurora, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/183,240

(22) Filed: Jun. 27, 2002

(51) Int. Cl. G09G 5/00

(52) U.S. Cl. 345/745

(57) ABSTRACT

Methods and apparatus for delivering an electronic publication to a user via a broadcast communication system are disclosed. A disclosed method includes receiving content components and content provider preferences. Content provider preferences are selected based on the user's preferences to provide a first selection, and the publication is assembled from the first selection. Content components are selected from the first selection based on the content provider preferences to provide a second selection, and the publication is assembled from the second selection. The publication is assembled based on the content provider preferences. A disclosed apparatus includes a tuner that receives the content components on a broadcast channel, a database containing information about the user, a content component selector that selects content components based on the information about the user, and an assembler that assembles the publication based on the information about the user and the content provider preferences.

### FIELD OF THE TECHNOLOGY

The invention relates generally to electronically distributed publications, and, more particularly, to electronic distribution of customized content via a digital broadcast signal.

### DESCRIPTION OF THE PRIOR ART

The desire to deliver electronic publications to an end user (i.e., a subscriber to the publication) via long distance electronic communication has long been known. In addition, publication providers and distributors have attempted to customize their publications to meet the interests of the end user to provide a product specifically suited for the end user.

Many proposals have addressed these issues. For example, delivery of electronic publications via email or via an Internet web page dedicated to the user has long been known. Based on information gathered about the user, a publication provider or distributor may modify the content and/or layout of the publication to meet the interests of the end user. The customized publication is then electronically mailed to the end user, displayed on a web page that is specifically designed for the end user or a group of end users having similar interests, or otherwise involve some form of “pull down” technology that requires the user to log onto a database to retrieve the customized publication. The end user could also download the publication to a personal computer or print out a hard copy of the publication. Alternatively, the publication providers or distributors have electronically developed customized publications that are printed as a hardcopy and delivered via conventional mail.

While many of the above-noted methods have been successful in developing and distributing customized publications to end users, there remains room for improvement.

### SUMMARY OF THE INVENTION

In accordance with an aspect of the invention, a method is provided for delivering an electronic publication to a receiving user via a broadcast communication system. The method comprises receiving a plurality of content components and content provider preferences at a receiver; selecting at least one content component from the plurality of content components based upon user preferences to provide a first selection of content components. The user preferences are predefined by the receiving user. The method further comprises selecting at least one of the content components from the first selection of content components based upon the content provider preferences to provide a second selection of content components; and assembling the publication from at least the second selection of content components to create an assembled publication.

In accordance with another aspect of the invention, a method is provided for delivering-an electronic publication to a receiving user via a broadcast communication system. The method comprises receiving a plurality of content components and content provider preferences at a receiver; selecting at least one of the content components from the plurality of content components based upon user preferences to provide a first selection of content components; and assembling the publication from one or more of the content components of the first selection of content components in accordance with the content provider preferences to create an assembled publication. The content provider preferences include preferences as to the arrangement of content components in the publication. The user preferences are predefined by the receiving user.

In accordance with yet another aspect of the invention, an apparatus is provided for retrieving a publication from a broadcast datastream transmitted via a broadcast channel. The broadcast datastream contains a plurality of content components and content provider preferences. The apparatus comprises a tuner arranged to tune to the broadcast channel to receive the broadcast datastream; a database containing information about a user; a content component selector cooperating with the database to select at least one content component from the plurality of content components to produce a selection of content components based at least in part on the information about the user; and an assembler cooperating with the content component selector and the database to assemble the publication based at least in part on the information about the user and at least in part on the content provider preferences.

Other features and advantages are inherent in the disclosed apparatus or will become apparent to those skilled in the art from the following detailed description and its accompanying drawings.

### BRIEF DESCRIPTION OF THE DRAWINGS

FIG. 1 is flowchart illustrating a disclosed method for delivering a customized publication to an end user;

FIG. 2 is a diagram illustrating a disclosed system for receiving and assembling a customized publication;

FIG. 3 is a diagram illustrating a disclosed content profile describing attributes of a content component;

FIG. 4 is a diagram illustrating an expanded view of a disclosed content profile describing the attributes of a content component;

FIG. 5 is a diagram illustrating a disclosed layout description;

FIG. 6 is a diagram illustrating an arrangement of areas for content components within a publication according to a layout description;

FIG. 7 is a diagram illustrating a schematic illustration of an apparatus for delivering a publication to an end user;

FIG. 8 is a diagram illustrating a disclosed user profile describing the preferences of an end user;

FIG. 9 is a diagram illustrating an expanded view of a disclosed user profile describing the preferences of an end user;

FIG. 10 is a flowchart illustrating a disclosed method of scheduling the download of a publication;

FIG. 11 is a flowchart illustrating a disclosed method of downloading and assembling the publication for an end user; and

FIG. 12 is a flowchart illustrating a disclosed method of comparing a content profile to a user profile.

### DETAILED DESCRIPTION OF THE EXAMPLES

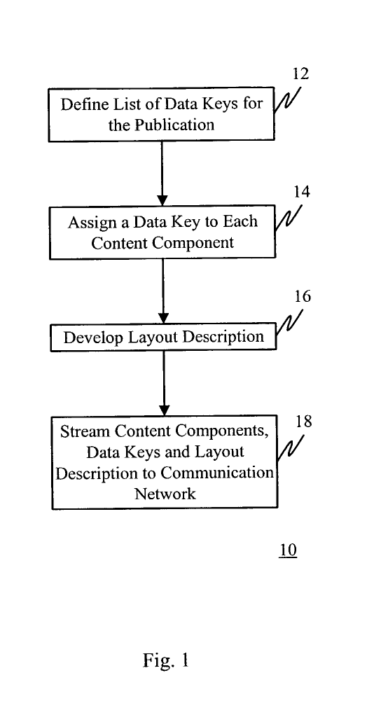

A method 10 of delivering an electronic publication to an end user is shown generally in FIG. 1. Although the method 10 is particularly well suited for use in delivering customized electronic periodical publications such as magazines, newspapers or the like, persons of ordinary skill in the art will readily appreciate that the teachings of the instant invention are not limited to any particular type of publication. On the contrary, the teachings of the invention can be employed with virtually any type of publication that can be transmitted in electronic form where it is desired to customize the publication to an end user's interests and preferences. Thus, although the method 10 will be described below primarily in relation to magazines, newspapers and other periodicals, persons of ordinary skill in the art will readily appreciate that the method could likewise be used with electronic books, pamphlets, Internet web pages, etc.

Generally, the method 10 defines a list of data keys which act as content profiles at block 12, assigns a data key to each content component at block 14, develops a layout description at block 16 and transmits the content components, content profiles and layout description to an end user at block 18. Personalized information relating to the end user may also be transmitted in the datastream at block 18 to be included in the assembled publication. The end user generally has a receiver, describer further below, that receives the datastream. The content components are selected and the publication is assembled according to the end user's preferences, the content provider's preferences and/or the layout description.

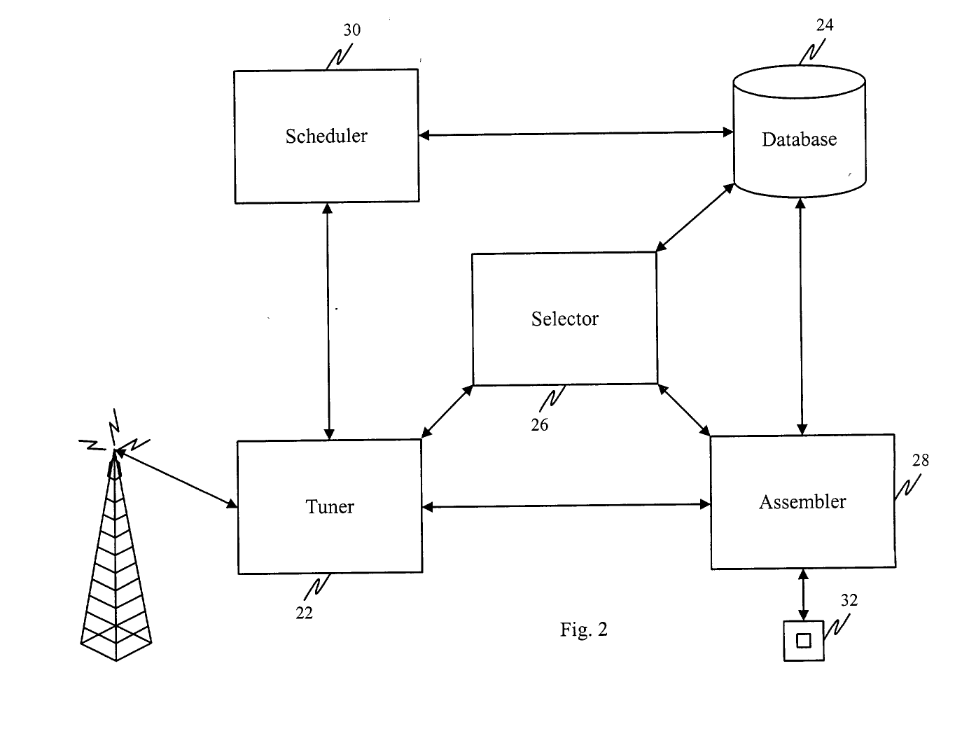

FIG. 2 is a diagram illustrating an exemplary system 20 for retrieving and assembling a publication from a broadcast datastream. The system 20 includes a tuner 22, a database 24, a selector 26, an assembler 28 and a scheduler 30. All or part of the system 20 and its functions may be implemented as hardware, software or firmware, though preferably the system 20 is implemented as software on a receiver. The system 20 may further be implemented in one or more routines, such as those described below, for the scheduling, reception, selection and assembly of the content components, content profiles and layout description into a publication customized for the end user.

Generally, the tuner 22, which may include one or more tuners for receiving multiple channels concurrently, receives a broadcast datastream containing the content components, content profiles and layout description 300 to be used in assembling the publication. In order to receive the datastream on the appropriate channel at the appropriate time, the tuner 22 cooperates with the scheduler 30 which determines the optimal schedule for when to receive a publication on a broadcast channel. The scheduler 30 determines or updates the optimal schedule by cooperating with the tuner 22 to receive a list of all publications, times and channels from one or more broadcasts. The tuner 22 tunes to the appropriate channel at the appropriate time to receive the broadcast datastream. The database 24 contains information about the end user, including information regarding the end user's preferences as to the selection of content components and the arrangement of the content components. The database 24 may further contain personalized information specifically about the end user, such as demographics, personal information, personal financial information, etc. that may be inserted into the assembled publication. The selector 26 receives the full datastream from the tuner 22, or only that part of the datastream that includes the content components, content profiles and layout description specific to the publication to be received, and cooperates with the database 24 to select content components from the datastream based on the information about the end user. Alternatively, all of the content components, content profiles and layout description of a publication may be stored in a memory buffer from which the selector 26 selects the content components. The selection is generally done by comparing the information about the end user with the content profiles of each content component. The selector 26 may further select content components from the datastream or from the results of the selection based on the end user's information using preferences of the content provider. The assembler 28 assembles the publication from selected content components (based on the information about the end user, the preferences of the content provider and/or details regarding the media device) according to the layout description. The assembler 28 may also take into account the end user's information by cooperating with the database 24 and/or the content provider's preferences in assembling the publication. The assembled publication may be stored in a memory buffer or a database, such as database 24, until it is viewed, downloaded or erased. A communication port 32 may also be provided either as part of or coupled to the assembler 28. The communication port 32 cooperates with the assembler 28 and communicates with an external media device for presenting the assembled publication to the end user. The assembler 28 may also take into account formatting requirements of the media device when assembling the publication.

Referring again to FIG. 1, for purposes of identifying and representing the characteristics of various editorials, advertisements and other content components within a publication, the method 10 develops a list of data keys at block 12 for a particular publication. While the content components will generally be referred to as editorials and advertisements throughout this disclosure, content components may encompass any aspect of a publication, including but not limited to editorials, articles, advertisements, pictures, video, audio, Internet hyperlinks, miscellaneous images, graphics, or text (e.g., publication logo and title), pages of a publication or even the overall publication itself, and should not be construed as being limited to any particular part of the publication.

Once the list of data keys has been developed, each content component is assigned a data key at block 14. In one example, the data key acts as a content profile defining the characteristics of the particular content component to which the data key is assigned. For example, the content component may be an editorial on baseball. The editorial may be targeted and/or generally of interest to male and female end users between the ages of 25 and 55. A data key representing these characteristics (i.e., subject: sports; targeted gender: male and female; targeted age groups: 25-55) would be assigned to the editorial.

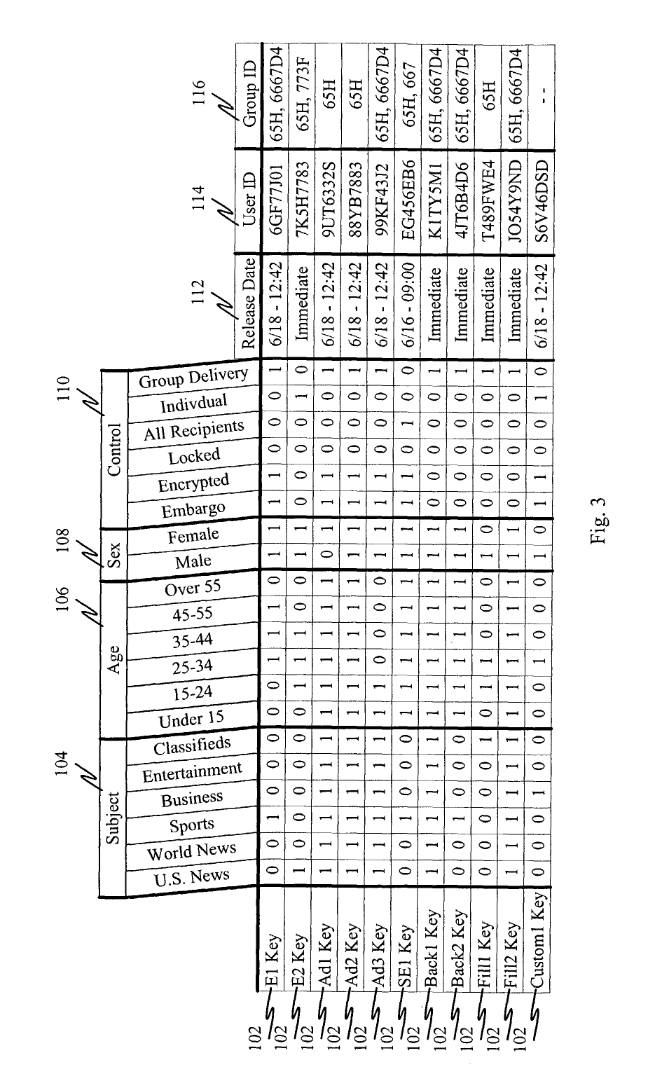

The data key may also include “filler” material associated with a content component. The “filler” material would be used if, for example, after assembly of the publication the content component is not large enough to fill leftover space, but the leftover space is too small to insert another content component. The “filler” material may include graphics, advertisement information, subscription information, etc. and may vary in size to accommodate the amount of leftover space. Alternatively, the “filler” material may be one or more content components which are made part of the assembled publication wherever there is leftover space available. In yet another alternative, the “filler” material may be stored locally in the database 24 to be called up if there is any leftover space available or transmitted as part of the layout description. As a content component, the “filler” material may have a data key 102 as shown below in FIG. 3 as the “Fill1 Key” and “Fill2 Key”, so that the “filler” material may be commensurate with the end user's preferences.

The data key may further identify characteristics of content components specifically customized for the end user or formatting content components that are added to create an appearance amenable to the end user. For example, the end user may prefer a particular background or border for a particular type of content component or for all content components. Additional content components representing various backgrounds, borders or other formatting may be broadcast with other content components or stored locally at the end user's receiver, media device, database 24, etc. The end user may also be sent a variety of formats in a prior broadcast and periodically updated with other formats. The end user can select or create preferred formats and dictate how they may be used in assembling the publication (e.g., all sports articles are to have a background reflecting sports subject matter). The formats may relate to specific subject matter which can be indicated in the data key, or the background may be simply neutral (e.g., an all-blue background). The formats may relate to color, graphics, audio, video, etc. For example, the end user may prefer to listen to a particular song or style of music when reading a particular article. When the article is displayed or otherwise presented to the end user on the media device the music is played, and stopped when the end user moves on to another article.

FIG. 3 depicts an example of a content profile implemented as a data key 102 that may be assigned to a content component. The data key 102 is a series of bits where each bit represents a different characteristic or category about the content component to which the data key 102 is assigned. For example, the data key 102 may include several bits dedicated to defining the subject matter of the content component in the subject category 104. As shown in FIG. 3, a series of bits may be used for the subject category 104, where each bit represents a different subject (e.g., U.S. News, World News, Sports, etc.).

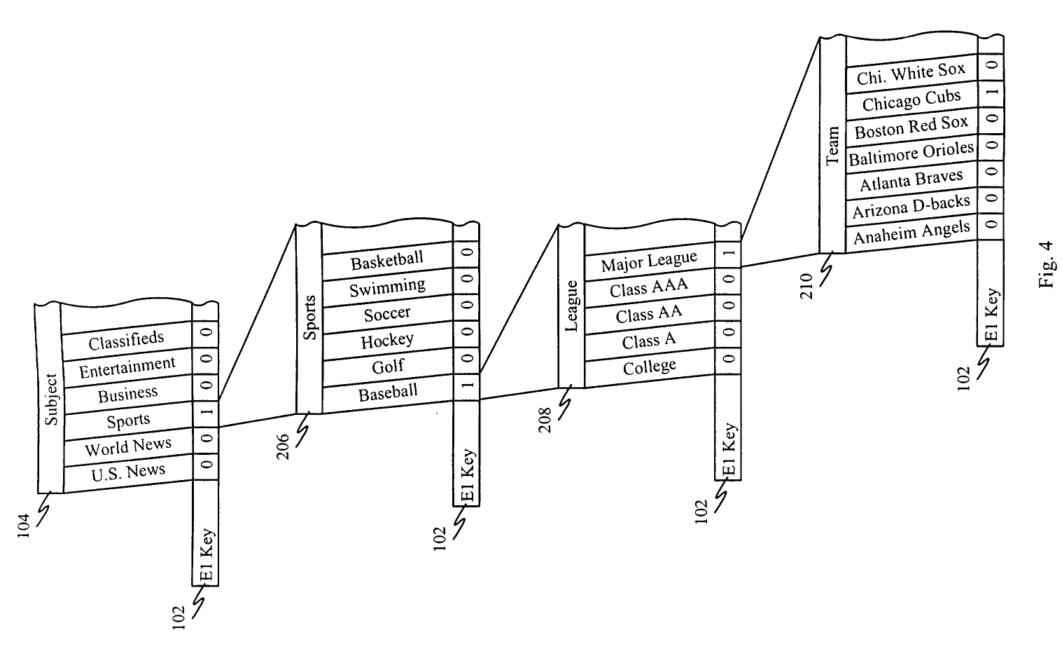

Although the data keys 102 illustrated in FIG. 3 associate only a single bit with each subject, with a ‘1’ signifying that the content component relates to that subject, the data keys 102 may comprise several bits to describe a category, including several levels of detail regarding a particular category where a ‘1’ further signifies an additional level of data relating to the selected category. For example, as shown in FIG. 4, a first series of bits may denote different types of subject matter in the subject category 104 such as “U.S. News,” “World News,” “Sports,” “Business,” etc. For each type of subject matter relating to the content component, the data key 102 for that content component (i.e., E1 Key 102) may then provide a further level of detail regarding the selected subject. The first level of the data key 102, designated as the E1 Key 102, denotes that the content component is about “Sports.” A second level then details the specific kinds of sports that the content component may relate to in a sports category 206, in this case “Baseball.” Further levels of detail may also be included such as a specific baseball league(s) category 208, a category of teams 210 within the league(s), players on the teams, etc. A similar variety of levels may be used for other categories as well to define the overall content profile of the content component, with each level providing a further set of details describing the characteristics of the content component.

Furthermore, the number of levels, how they are defined and what they each relate to can vary from publication to publication. For example, the data keys of FIGS. 3 and 4 generally have been described as relating to a newspaper or news magazine. The categories may be defined differently if the publication is a book, a different type of newspaper or magazine, a pamphlet, etc. A receiver that reads the data key could be programmed to recognize how the first level of categories are defined for a particular publication and how subsequent levels are defined given the selected category in the preceding level. For example, the selection of “Sports” using a ‘1’ in the bit Field designated for sports would notify the receiver that the next level of bits would relate to different kinds of sports. Alternatively, if “World News” was selected, it would notify the receiver that the next level would relate to various aspects of World News. Alternatively, the data key may provide a header at the beginning of each level identifying the category to the receiver.

Referring again to FIG. 3, a further series of bits may be used to signify information regarding the type of end user the content component is targeted for, such as an age category 106 and a gender category 108. As with the subject category 104, categories regarding the targeted audience may also be broken down into various levels of detail. The data key 102 may also include other preferences that are provided by the content provider, such as various control options 110. The content provider includes any entity at any point in the delivery system that aids in providing an end user with a publication (e.g., publication source, editor, publisher, distributor, service provider, etc.).

As shown in FIG. 3, the content provider may include its own preferences regarding the content component via a control category 110 with which to control where and when the content component is sent. For example, the control category 110 may include a particular date and time that the content provider wishes the end user to receive that particular content component by setting an “Embargo” bit to ‘1’. A “Release Date” 112 is then also provided if the “Embargo” bit is set. Otherwise, the “Release Date” 112 may be assumed to be immediate. An “Encryption” bit may also be provided to indicate that the content component is encrypted and requires an appropriate decryption key so the content component may be accessed. Even though a content component is “Embargoed” until a certain date and time, it may still be broadcast to the end user prior to the “Release Date”. For example, the content component may be encrypted with a general encryption key and broadcast to an end user's receiver where it is stored. The end user is only given the general decryption key with which to decrypt the content component when the “Release Date” occurs or is about to occur. On or about that date and time, the receiver may be sent the general decryption key. The general decryption key may be encrypted itself using a key specific to the end user. The end user or the receiver may then decrypt the general decryption key which in turn may decrypt the content component at the date and time specified in the “Release Date”. This scenario prevents the end user from accessing the content component prior to its “Release Date” without spending excess processing time and energy to encrypt the same content component(s) for several end users using each end user's specific decryption key. Of course, the encryption of the content component may be specific to the end user's decryption key in cases where the content component contains sensitive information regarding the end user. A “Locked” bit may also be included to prevent certain end users from receiving some content components.

Having a “Release Date” 112 associated with the content component allows the content provider to schedule delivery of different editions of the publication, special editions, updates, different issues, etc. at different times. For example, an issue of an electronic magazine may include content components each having a data key 102, as part of its regular July issue (i.e., E1 Key, Ad1 Key, Ad2 Key, Ad3 Key). The magazine, and hence its content components, has an issue date (i.e., a “Release Date” 112) of June 18 and an issue time of 12:42 pm (also part of the “Release Date” 112). However, a breaking story, represented as a content component having a data key designated as “E2 Key” may develop before the scheduled issue data such that the content provider would like immediately to release the story to certain subscribers. In this case, the “Embargo” bit is not set and “Release Date” 112 is immediate. Alternatively, a special edition of the publication, with a data key designated as “SE1 Key”, may be sent to interested subscribers prior to the scheduled issue date in which case the “Embargo” bit remains set but the “Release Date” 112 is modified accordingly.

To send a content component to all subscribers of the publication, an “All Recipients” bit is provided in the data key 102. This allows the content provider to send a particular content component to all subscribers of the publication. In another example, this feature is used to allow the content component to be sent to subscribers and non-subscribers alike, or just non-subscribers. In such a case, the content component is sent to each end user regardless of the end user's level of interest in the subject matter of the content component. The “All Recipients” feature may be useful, for example, with special editions of a publication. The special edition may relate to subject matter that is of general interest to all end users regardless of their normal preferences on the subject matter. Therefore, the “All Recipients” bit may be used as an override function so that the content component(s) of the special edition is not filtered out by a receiver (described below) even if the content profile does not otherwise match with the end user's preferences.

An “Individual” bit may be included to allow the content provider to direct a content component to a particular end user. As with the “All Recipients” bit, the “Individual” bit may be used as an override function to deliver the content component to the end user regardless of the end user's preferences. Alternatively, the content component may be personalized or otherwise specific to an end user as opposed to or in addition to being customized for the end user based on the end user's demographics and interests. For example, if it is time for the end user to renew his subscription to the publication, a personalized renewal request may be sent to the end user as a reminder to renew the subscription.

As another example, the content component may be a combination of personalized information and public information. An end user's personal financial information, such as an end user's stock portfolio, may be transmitted as a content component to only that end user. The stock information may then be displayed as a special section for the end user to easily review his stock portfolio or any other personalized information. Personalized information may also be stored locally in the database 24 and/or combined with other content components (e.g., stock quotes not pertinent to the end user) where the personalized information is highlighted among the other information not specific to the end user. Alternatively, data representing the personalized information (e.g., the end user's stocks) may be used to create graphs, charts or other representations relating to the personalized information. For example, the graphs or charts may relate to how well the end user's stocks are doing. These graphs or charts may be produced by the content provider or at the receiver using software that can recognize and analyze the appropriate information from among the general information. To these ends, a User Identification (“User ID”) 114 is also included in the data key 102 to uniquely identify the end user as the recipient of the personalized information.

The data key 102 designated “Custom1 Key” is an example of a content profile indicating that its associated content component is customized for a specific end user, such as for a personalized subscription renewal notice. As can be seen, the “Custom1 key” may still indicate the subject matter of the content component, as well as the demographics of the intended end user which are still useful in assembling the publication in accordance with the end user's preferences (e.g., preferred layout based on subject). In addition, the “Individual” bit is set and a “User ID” is defined. The “Group ID” (described below) in this example is left empty given the content component is customized for a specific end user, though content components may be customized for groups of end users as well, such as members of a household, in which case the “Group ID” would be applicable.

To send a content component to a particular group of users, a “Group Delivery” bit may be set. A group identification (“Group ID”) 116 is included to uniquely identify one or more particular groups of end users. The groups may include the subscribers to the publication, several end users within a particular household, within a particular geographic region, end users having similar interests, or otherwise grouped for any of a number of reasons. This option may also be used as an override feature to each end user's preferences. In addition, the “Group Delivery” bit may be used by end users to send information or content components to a particular group of end users via a return channel, phone line, interactive television, etc. For example, an end user may have a classified advertisement to be placed in a publication. The end user may enter information to be included in the classified advertisement with instructions that the advertisement be sent to only a certain group of end users (e.g., those with a particular interest in what the end user is offering, those within the local geographic region of the end user, etc.). The end user may then upload the advertisement and instructions to the content provider to be included in the publication or as an update to existing publications that run such advertisements.

In addition to using the “User ID” 114 or “Group ID” 116 to target certain content components to a particular end user or group of end users, the “User ID” 114 and “Group ID” 116 may also be used as a form of authorization (e.g., the “Group ID” 116 may identify the subscribers) such that a receiver that does not have the unique “User ID” 114 or “Group ID” 116 corresponding to the identification on the content profile will not store the content component.

The above data key 102 includes categories and options that permit the content provider to retain some control over the inclusion of the content component in the final assembled publication while still allowing customization of the overall publication in accordance with the end user's preferences. For example, as seen from FIG. 3, a first editorial has a data key designated as “E1 Key” that includes multiple bits where each bit corresponds to a different aspect of the editorial. In particular, the editorial is on the subject of sports and is targeted to end user's between the ages of 25-55 and either male or female. The editorial is further “Embargoed” so that it will not be released until June 18 at 12:42. Finally, the editorial is meant for all intended recipients of the publication (e.g., subscribers). On the other hand, a first advertisement has a data key designated as “AD1 Key” signifying that the advertisement relates to all subjects and all age groups of women. In other words, the advertisement is directed to women. The advertisement is also to be released on June 18 at 12:42 and is to be sent to all subscribers, though the previously-mentioned characteristics will drive the advertisement only to female subscribers. Both the editorial and the advertisement may be part of the same publication to be assembled at the end user's receiver. The content components may be reused to provide the same publication to different end users, such as different household members, where a different version of the publication is assembled according to each end user's preferences without having to download the same content components over and over for each end user.

The correspondence between the end user's preferences and the content profile is described further below. While the above has disclosed a data key as a content profile describing the characteristics of a content component and content provider preferences, persons of ordinary skill in the art will readily appreciate that content profiles having other methods and forms of representing the characteristics of the content component and content provider preferences could likewise be employed. For example, the data key may also include keywords that describe with even more detail the subject matter, intended audience, etc. of the content component.

Referring again to FIG. 1, once a data key 102, or other content profile, has been defined by encoding the data key 102 with the characteristics of the content components and content provider preferences, the data key 102 is assigned to the content component as indicated at block 14. In order to present the content components to the end user in a coordinated manner (i.e., arrange the content components to be viewed in the assembled publication), a layout description is developed as shown at block 16. The layout description indicates the order and arrangement of the content components for assembly of the publication to be viewed by the end user, as well as other attributes such as font, size, color, etc. Some parts of the layout description may be embedded in the broadcast datastream whereas other attributes may be stored locally in the database 24. The locally stored layout information may relate to the end user's preferences whereas the transmitted layout information may be used as a default if there is no user preference. The layout description may include layout instructions for all or part of the publication to be sent to the end user. For example the layout description may only describe a layout for one page or a section of the publication, in which case the publication would include several layout descriptions.

In order to select and assemble the publication according to the preferences of the end user, the layout description may be a flexible layout that accommodates both fixed and variable print information. Fixed print information is generally information that will be included in every version of the assembled publication regardless of how it is customized for the end user, such as the title of the publication, the date, and other content components that the content provider wants included in every assembled publication. Variable print information is that information which may vary among the assembled publications according to the preferences of the end user and/or the content provider. The variable print information may include various advertisements, editorials, or other content components that may be chosen to fill a vacant area within a page. The choice of advertisement, editorial, etc. is dependent on the preferences of the end user and/or the content provider. Examples of flexible layouts can be found in U.S. Pat. Nos. 5,963,968; 5,987,461; 6,088,710; 6,205,452; 6,246,993; 6,327,599; and 6,332,149 which are hereby incorporated by reference in their entirety. Additional examples of combining variable information with fixed information can be found in U.S. Pat. Nos. 4,500,083; 4674052; 4,789,147; and 4,768,766 which are hereby incorporated by reference in their entirety. However, it will be understood by those of ordinary skill in the art that even the fixed data may be modified based on the preferences of the end user and/or the content provider. For example, while every version of the publication will include fixed data such as a title, the title may be variable as to font, size, color, etc.

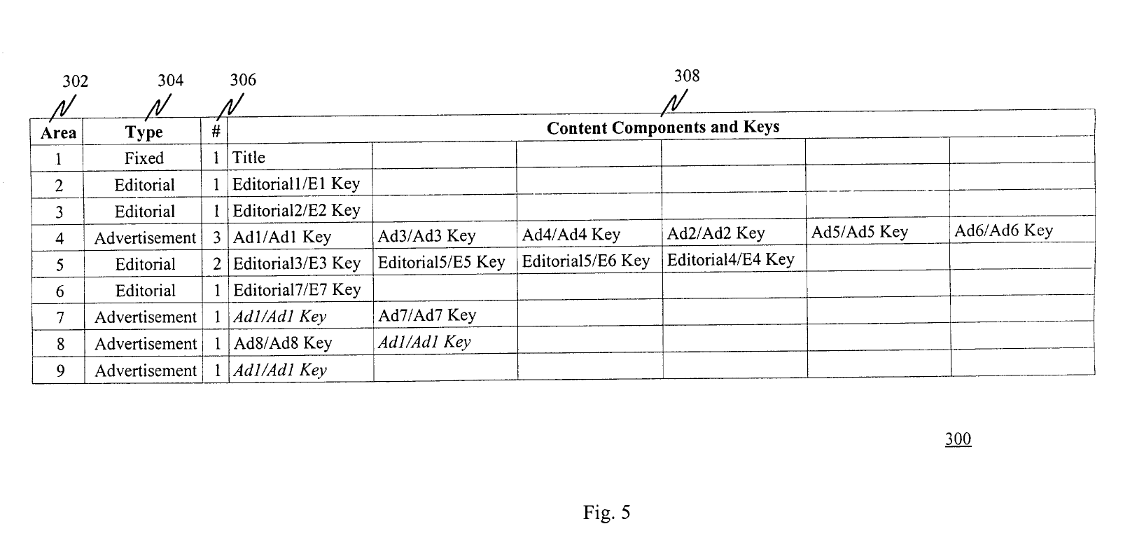

FIG. 5 is an example of a layout description 300 containing instructions for assembling the publication from various content components, such as editorials and advertisements. As seen in FIG. 5, each available area 302 is associated with fixed or variable information where the listing of areas 302 (i.e., Areas 1-9) is indicative of the order of presentation (i.e., title, editorial, editorial, advertisement, editorial, editorial, advertisement, advertisement).

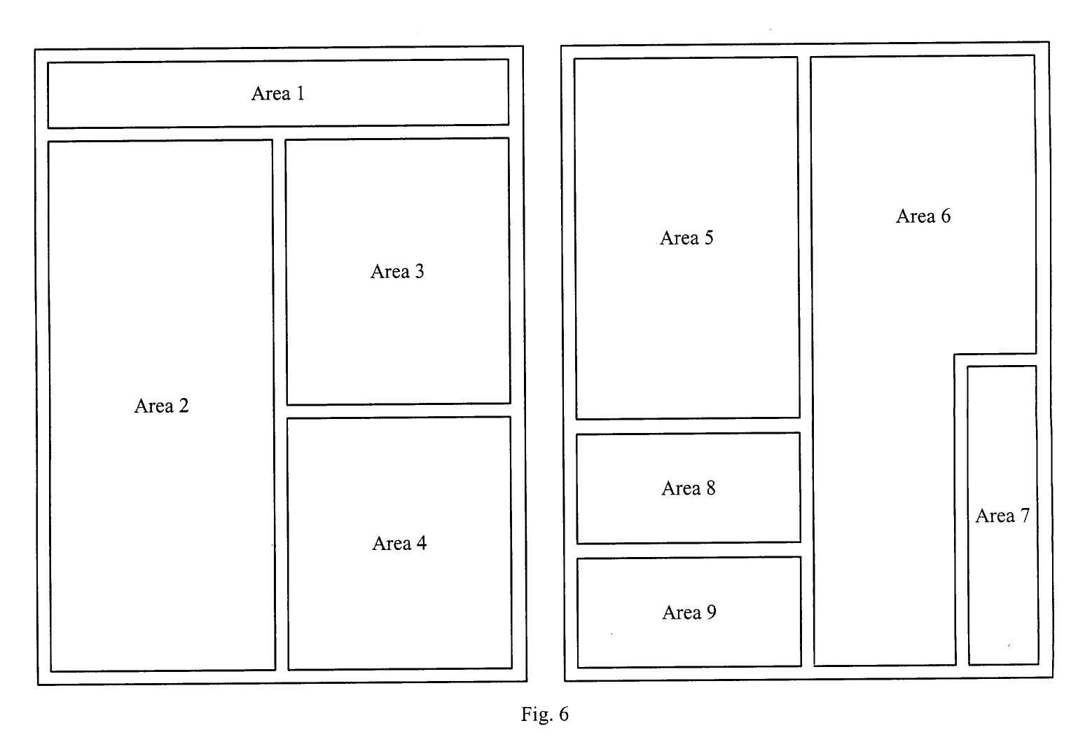

FIG. 6 is an example of how the content components for a publication may be arranged according to the layout description 300. A content component is to be assigned to each area 302 based on the end user's preferences and/or the content provider preferences. Though the areas 302 are shown in a specific arrangement in FIG. 6, this arrangement is merely given by way of example. While, one example of the assembled publication includes visual publications that can be displayed on a media device having visual capabilities such as a laptop computer or PDA, the assembled publication may also be assembled as an entirely audio presentation. The areas 302 may therefore correspond to periods of time and order of presentation over time. The areas 302 may further be interspersed with audio markers that allow a user to jump from one part of the audio presentation to another. For those content components that cannot be represented as audio (e.g., graphics, pictures, videos, Internet hyperlinks, etc.) the publication may either delete any reference to these content components or provide audio instructions as to where and/or how to view such content components. A similar scenario may exist with solely video presentations (e.g., if the media device is without audio capabilities) such that all audio is subtitled to coincide with the video. Instructions may be displayed on how to access content components that are unable to be displayed. The assembly of the publication is arranged based on characteristics of video. Therefore, the layout description may refer not just to a visual layout but also a layout over time. Those of ordinary skill in the art will recognize that numerous manners of presenting the publication are available and may be dependent on the capabilities of the equipment involved, and that any incompatible formats may be substituted with alternative manners of presentation. However, for ease of explanation, a text based presentation that may include some audio, video, Internet hyperlinks, etc. will be described herein.

Each area 302 may be modifiable in terms of size, placement, and/or proportions. For example, as described further below, Area 4 is to contain three advertisements selected from a possible six advertisements. The size or proportions of Area 4 may be dependent on which content component is chosen because AD1 may have a larger size or different proportions than Ad3.

In addition, surrounding areas may also have an effect on an area 302 depending on what content component(s) may be chosen for the surrounding areas. For example, Area 2 is to contain Editorial 1, with no other content component as an option (as described below). Given that Editorial 1 is the only possible content component, the size, placement and/or proportions of Area 2 may be predefined. However, Area 4 may be variable in terms of size, placement and/or proportions depending on which content components are chosen, and this may have an effect on Area 2. Therefore, an area 302 may be modifiable to accommodate whatever content component is chosen for that particular area and/or for surrounding areas. The arrangement of areas 302 according to the layout description 300 may therefore relate only to general positions of the areas 302 within a page of a publication or anywhere within the publication itself. For example, as shown in FIG. 6, Area 4 is placed at the bottom-right of the first page. However, depending on the content component chosen for Area 4 and/or surrounding content components, Area 4 may be moved up, to the left or even to another page, if necessary. Area 4 may also be resized or re-proportioned. Additionally, Area 4 may begin on one page and continue on the following page or another subsequent page, such as with a newspaper where an article may begin on the first page with directions to a subsequent page to view the remainder of the article. As a further example, Area 6 is generally placed on the entire right side of page two, subject to Area 7 being placed at the bottom-right. However, the size of Area 7 may affect how Area 6 is proportioned around Area 7.

An additional factor that may affect the size, placement and/or proportions of an area 302 includes content components that are additionally included or replace existing content components of an already assembled publication (e.g., updates to the publication). The layout description 300 may therefore take into account content components that may be added later and adjust the remaining content components and areas 302 accordingly. Other factors may also have an effect on the size, placement and/or proportions of an area 302 such as the type or size of font used, or any other factors that go into arranging the layout of a publication, as understood by those of ordinary skill in the art.

Other areas 302 within a publication may be fixed as to size, placement and/or proportions. According to the layout description 300, the first page includes Area 1 at the top of the page. As described below, Area 1 is reserved for the title of the publication and is considered fixed information. Therefore, its placement may be fixed to the top of the first page, though other aspects may be modifiable such as the size of Area 1, which may vary depending on the size and type of font used for the title, or vary based on the end user's preferences as to the size, font, style, etc. A table of contents or index may also be provided in the assembled publication which lists the various contents of the assembled publication and provides links with which the end user can immediately jump to a particular point in the publication. The table of contents may be considered a fixed area 302 at the front of the assembled publication (or wherever the table of contents is desired) but is still modifiable as to size and shape to accommodate the addition, deletion, or placement of the contents of the publication.

Referring again to FIG. 5, each area 302 has associated with it the type of data 304 it will display. For example, some areas 302 may be designated for fixed print information, such as the title, with other areas designated for variable print information (e.g., editorials and advertisements). Filler material may also be considered for each area 302 in case space is left over on a page that is too small for a regular content component such as an article. The layout description 300 can treat the filler material as “floating” such that it is considered for each area 302 or page if there is remaining space left on the page. The layout description 300 further includes the number 306 of content components that may be presented in a given area 302. Each area 302 is further associated with one or more content components and associated data keys 308, all of which may be included in the layout description 300. For example, Area 2 is designated to contain one editorial where the editorial is Editorial 1, because there are no other editorials to choose from. This may be due to the content provider exercising control over what the end user will see, as described above.

Area 4, however, is designated to contain three advertisements wherein there are a total of six advertisements to choose from. Again, each potential advertisement is associated with a data key. The selection of which advertisements to place in Area 4 may then be dependent on the end user's preferences and how they relate to the characteristics of each potential advertisement. However, the content provider still has influence over which advertisement is chosen for Area 4. For example, the order of potential advertisements for Area 4 as shown in FIG. 5 is indicative of the content provider's preferences as to which advertisement is chosen (i.e., AD1 is preferred over Ad3, Ad 3 is preferred over Ad4, etc.). Should the end user's preferences be compatible with four of the six possible advertisements (e.g., Ad1, Ad4, Ad2 and Ad6) when there is only room available for three advertisements, the content provider's preferences are taken into account as to which advertisements are chosen from the end user's selection based on their listed order (e.g., Ad1, Ad4 and Ad2). Alternatively, should the end user's preferences only be compatible with fewer advertisements than the amount of space available (e.g., Ad3 and Ad4), then the third advertisement may be chosen based on the content provider's preferences (e.g., Ad1). In yet another alternative, the advertisements may be “time-sliced” wherein one advertisement may be shown for a particular period of time to be replaced with another advertisement for another period of time. The advertisement may be displayed in rotation based on specified periods of time or upon the end user viewing the advertisement (e.g., each time the end user views the page, a new advertisement is shown).

As a further option, if there is a content component that is unselected based on the end user's preference but that the content provider would prefer to be at least somewhere in the assembled publication, then that content component may be carried over to other areas 302 in the publication where it may be considered as an option. For example, the content provider prefers that Area 4 contain AD1 over all other ads as seen by the order in which the advertisements are listed, though the end user's preferences exclude Ad1. However, rather than require that AD1 be placed in Area 3 and override the end user's preferences, the content provider may still allow AD1 to remain an option that may be selected based on the end user's preferences in another area 302. If the end user's preferences do not choose AD1 for Area 4, then Ad1 may become an option for the next area 302 that an advertisement will be selected from (i.e., Area 7). Again, the potential advertisements in Area 7 are listed in order of the content provider's preferences. If the user's preferences do not choose AD1 over Ad7, then AD1 becomes an option for the next advertisement area (i.e., Area 8), and so on until AD1 is selected or all available areas 302 are occupied. If, however, AD1 is chosen for one of the areas 302, then it need not be included as an option for subsequent areas 302. If AD1 is not chosen at all, it may be included regardless of the end user's preferences, but the end user may be allowed the option of bypassing or skipping AD1 when viewing the assembled publication. In short, a content component may be used as a selectable option among several content components from one area to the next until it is finally chosen over the other content component options or until no further areas 302 are available.

Alternatively, to ensure that the content component is included at least somewhere within the assembled publication, the layout description 300 may include at least one area (e.g., Area 9) that has no content components associated with it. Therefore, when a content component preferred by the content provider has not been chosen over other content components, it may be included in Area 9 where there are no content components to choose from. The content component may also be “time-sliced” with other content components, as discussed above. The same techniques could be applied to several or even all content components such that at some point in the assembled publication all content components are included but the publication is assembled according to the end user's preferences. In effect, the end user's preferences drive the arrangement and selection of the content components, while the publisher's preferences may also account for the arrangement and selection of the content components.

While the layout description 300 has been described in relation to the type, number, and order of presentation, persons of ordinary skill in the art will readily appreciate that other details regarding the assembly of the publication may be included in the layout description 300 such as content component positioning, color, font, size, etc. These aspects may also be variable and dependent on the type of media device that is used to view the assembled publication. Because the types of media devices may vary among various end users (e.g., television, computer, personal digital assistant (PDA), audio device, etc.), the layout description 300 and content components may be written in Extensible Markup Language (XML) or another comparable markup language that will allow the publication to be displayed in a variety of formats. An XML formatting language, such as Extensible Stylesheet Language Transformations (XSLT) or another data formatting language, which may be proprietary to the content provider, may be used to explain to the receiver how the XML document should be reorganized or assembled into a data structure that is compatible for displaying on the media device. The XML document may also include default formatting that is transmitted with the layout description or stored locally at the receiver. The default settings may be used if there are no overriding end user preferences or if the media device is unable to use the specified format. For example, a purely audio device would be unable to play video or show graphics, text or Internet hyperlinks. However, the default settings may include audio instructions on where and how to view the video or graphic (e.g., on a website), and the text may be recited as audio to the end user.

Referring again to FIG. 1 at block 18, to deliver the publication to an end user the layout description 300, content components and content profiles for a particular publication are streamed to the delivery system for further distribution to end users as one or more data files. As part of delivering the publication to an end user, the datastream may be encrypted such that only those receivers with a decryption key (e.g., subscribers) may decode the datastream. If the content components contain sensitive or personal user information, the datastream (or those parts that contain the sensitive or personal information) may be encrypted so that only the end user's key may decrypt the information. The datastream may be of any type suitable to transfer various types of files as part of a mass distribution or broadcast, such as MPEG, MPEG-2, Internet Protocol, etc. and may be dependent on the type of communication system being used to distribute the publication. The type of communication system used for distributing the datastream may include television cable, Ethernet, Internet, satellite, phone line, or any other communication system capable of delivering electronic data, and may be either digital or analog. Though this disclosure will describe the publication being delivered via a communication system used for television broadcasts, persons of ordinary skill in the art will readily appreciate that any other means of mass electronic distribution could likewise be employed without departing from the scope of the invention.

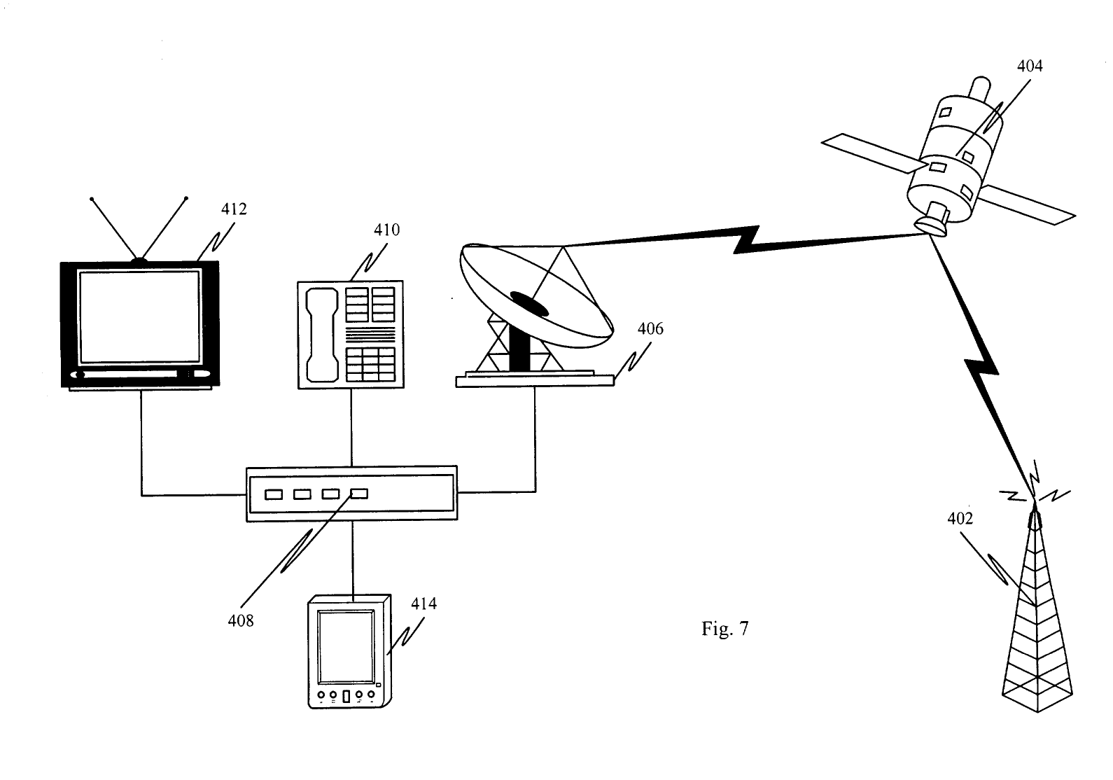

As shown in FIG. 7, the layout description 300, content components and content profiles relating to a publication are uploaded as a datastream from a base transmitter 402 to a satellite 404 or other form of communication system headend for further distribution to the end users. The datastream is then downloaded to various households equipped with a receiver 408 that receives the transmissions. In the case of a satellite distribution system, the end user may require a satellite dish 406 to receive the datastream as well as a receiver 408 with which to decode the datastream. Of course, as is known to those of ordinary skill in the art, the particular equipment required by an end user to receive the datastream is dependent on the type of communication system being utilized. Preferably, the distribution system is a television broadcast system such as a cable or satellite television broadcast system. Regardless of the communication system that is utilized, some form of receiver 408 will generally be used to receive the datastream which may be a computer, set-top box, digital video recorder, television, etc. Preferably, the receiver 408 contains a processor and a data storage device for receiving the datastream, and assembling and storing the publication from the content components.

To mass distribute the publication to several end users, the datastream containing the content components, content profiles and layout description is broadcast to every receiver 408 that receives signals from the headend regardless of whether the owner of the receiver 408 subscribes to the particular publication or not. In one example, the publication is delivered via television broadcast technology such as cable and satellite services where the datastream is broadcast to the end users over one or more broadcast channels. The television broadcast receiver 408, whether it be a video cassette recorder, a digital video recorder, a cable set top box, a television, etc., would then include at least one tuner 22 to tune to a particular channel carrying the datastream, though more than one tuner or the same tuner 22 may be used to tune to multiple channels simultaneously, such as for digital television which includes multiple signals or datastreams multiplexed together on a single channel. The channel(s) on which a publication is broadcast may be chosen based on the type of publication. For example, a channel may be used to transmit publications that have frequent updates, such as newspaper, whereas another channel may transmit weekly periodicals. Still another channel may transmit only specially requested publications and/or electronic books. Alternatively, each content provider may be provided with its own designated channel or transmissions may be multiplexed with existing television broadcasts. However, the channels may be allocated in any manner as understood by those of ordinary skill in the art.

In order to prevent unauthorized access to the publication, the tuner 22 is used to filter out or reject those datastreams carrying publications that the subscriber has not subscribed to. The tuner 22 of an end user who is a subscriber is programmed to receive the datastream carrying the subscribed publication. The filtering mechanism may be overridden by the content provider, if desired. The filtering may also be done by encrypting the datastream as described above, wherein only a proper decryption key will decrypt the datastream. Subscribers to the publication may be provided with the decryption key upon subscribing to the publication, which may then be programmed into the receiver 408 to automatically decrypt the datastream. End users without a decryption key will not be able to access the datastream and hence not be able to access the publication.

Alternatively, the datastream may include a code unique to the publication as a whole and each end user may have codes to all subscribed publications. The end user's codes may be stored in a memory on the receiver 408 which will reject those datastreams that the user does not possess a code for, or the receiver 408 may temporarily store the datastream and prompt the end user for the proper code. As described above, the content profile may include an identification unique to the end user (i.e., “User ID” 114) or a group of end users (i.e., “Group ID” 116), which will only allow that end user or group of end users to receive the publication. This identification may be used to identify the subscribers. If the codes match, the receiver 408 accepts the datastream and proceeds to assemble the publication. Otherwise, the datastream is not accepted by the receiver 408. Those of ordinary skill in the art will readily appreciate that various methods and techniques may be used to prevent unauthorized access, such as methods used for pay-per-view access to television programs or to scrambled certain channels.

To order subscriptions to a publication, renew old subscriptions to a publication or gain access to various sections of a publication, the receiver 408 may be equipped to allow the end user to order or renew a subscription, or obtain access to a section of a publication via a phone line 410 attached to the receiver 408 or through a return channel in the communication system (e.g., a return channel in interactive television). This may also be used to permit subscribers and non-subscribers alike to purchase specific publications or issues of a publication. The receiver 408, or other means such as an Internet webpage, touchtone telephone recording, media device, etc., may query the end user as to whether he would like to renew, subscribe or otherwise access the publication by prompting the end user on a display screen 412, computer, media device, telephone, etc. Once the end user subscribes to a publication, the end user's receiver 408 may automatically be updated with the codes or decryption keys necessary for the receiver 408 to accept the publication. Alternatively, the end user may be provided with appropriate access codes via email, regular mail, or other alternative delivery means for added security, which the end user can then manually input into the receiver 408 or media device. The receiver 408 may further be coupled to a portable media device 414, such as a laptop computer, a personal digital assistant (PDA), an audio device such as an MP3 player, etc. The connection may be hardwire, high bandwidth, optical (e.g., infrared), Bluetooth or other wireless technology, radio wave, etc. to allow the receiver 408 to upload the assembled publication to the media device 414 for viewing and/or listening by the end users.

To assemble the publication in accordance with an end user's preferences, the database 24 contains information about the end user and the end user's preferences. This information may be gathered in any of a variety of methods, such as polling the end user for personal or demographic information (e.g., age, gender, income, personal finance, employment, residence, etc.) as well as the end user's likes and dislikes regarding different aspects of a publication such as subject matter, author, etc. The end user may also be asked to rank what kinds of preferences are more important to him (e.g., subject matter preferences are more important than author preferences) and to rank each of his preferences with respect to each other (e.g., likes both baseball and hockey, but prefers hockey). In effect, the end user's preferences can be obtained at any desired level of detail from the most basic of information, such as demographic information, to more personalized preferences such as the order of subjects in which the end user reads a periodical (e.g., favorite sports teams first, then world news, then the remainder of the sports, etc.) or even the size of font the end user prefers.

In order to gather information about the end user, a variety of techniques may be employed, whether alone or combination. The end user may be asked to answer a series of questions when subscribing to the service for providing electronic publications and/or when subscribing to a specific publication. This may be done over the phone 410, via a hardcopy questionnaire, via a questionnaire over the media device 414, etc. Various other methods of determining the end user's preferences may also be used, such as prompting the user to rank his interest in various articles, advertisements or publications, including specific aspects regarding each content component such as the author, the subject matter, etc. The results of these rankings may be used to determine the end user's preferences regarding articles, advertisements, publications or other content components having similar characteristics.

The end user's preferences may further be determined based on monitoring the end user's reading habits so as to allow for continual upgrading and refinement in establishing the end user's preferences. For example, in an electronic newspaper the end user may have a specific order in which he reads his newspaper or prefer to articles by a certain author, subject, etc. This can be determined via the media device 414 by monitoring when, how long and how often an end user views an article. Other considerations may also be taken into account. For instance, the end user's reading habits may vary over periods of time (e.g., reading habits on a Sunday are different than reading habits on a Monday), vary depending on the end user's moods or vary as the end user matures or otherwise changes due to life experiences. The database 24, the media device 414, an offsite database, or the content provider may monitor this behavior and determine the end user's reading habits for further issues of the same publication or for different publications, as well as determine how the end user's preferences vary depending on the time or the end user's mood. The detected changes in the end user's reading habits may allow for potentially determining or predicting the end user's preferences. This may also allow for automatically adjusting publications including those publications that have already been customized or received by the end user. This information may further be used to suggest other publications, articles, advertisements, etc. that the end user may also be interested in. As mentioned, the collection of information about the end user may be done in any of a variety of methods whether alone or in combination, some of which have been described above. Such methods have been the subject of numerous patents and publications, any of which may be used to gather information about the end user. The particulars in implementing such methods are well known to those of ordinary skill in the art and will not be described further in this document.

The database 24 may contain media device-specific setup or formatting information according to the media device(s) 414 at the end user's location to allow various devices to be able to view and share the assembled publication, along with formatting information regarding the layout of the publication (e.g., backgrounds, background audio, etc.).

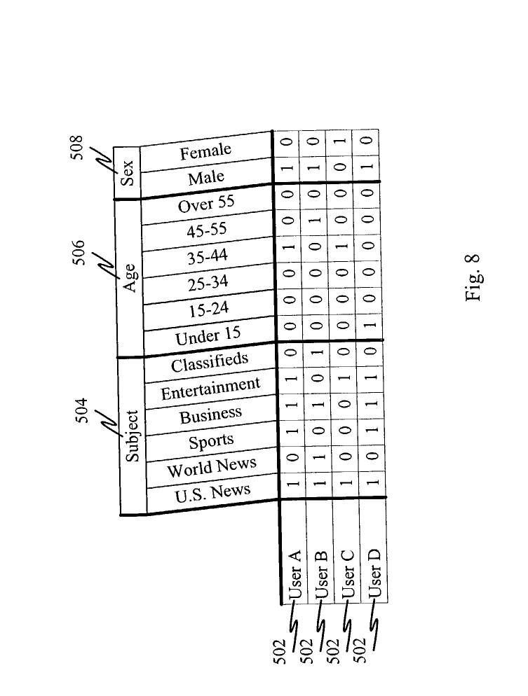

To assemble a customized publication from the content components in accordance with the user's preferences, the user preferences are organized into a user profile that resides in the database 24 which may be implemented either on the receiver 408 or coupled to the receiver 408. The database 24 may contain more than one user profile (e.g., multiple members of a household) or may contain user profiles that relate to a group of people (e.g., for sharing the same publication). An example of a user's profile 502 is shown in FIG. 8. The user profile 502 generally has the same format and categories as the content profile of each content component. For example, as shown in FIG. 3, the content profile included categories such as subject matter 104, age 106 and gender 108 which relate to the characteristics of the content component. As shown in FIG. 8, similar categories are used in the user profile 502 that reflect the end user's subject matter preferences 504, age 506 and gender 508.

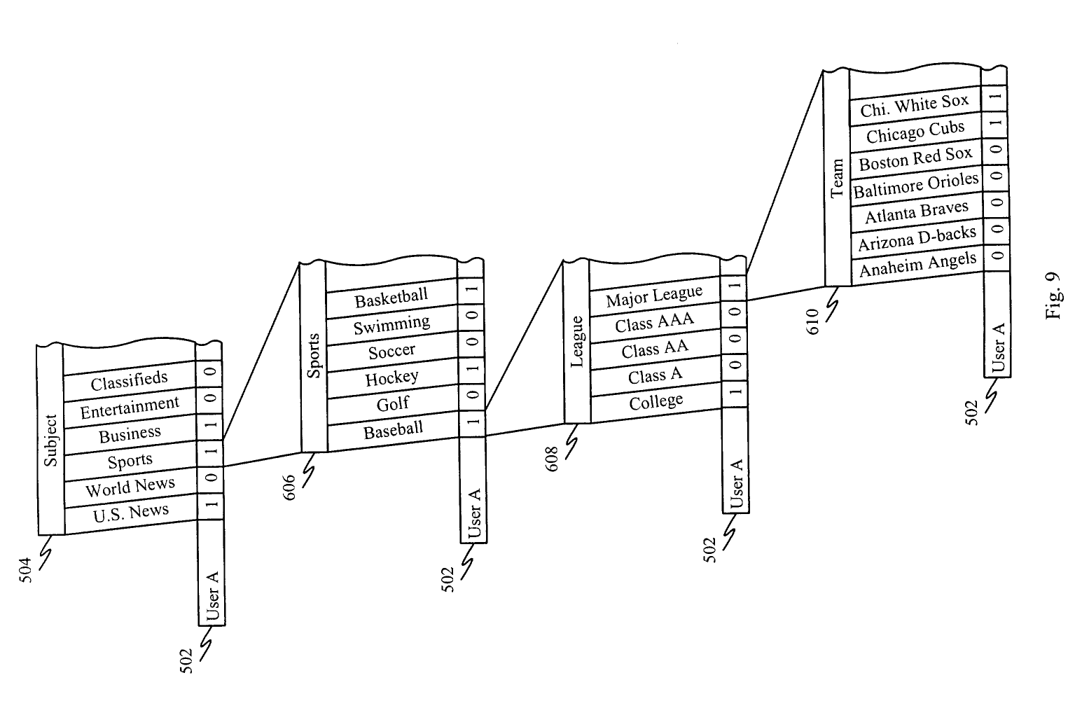

However, referring to FIG. 9, the user profile may include any level of detail that is desired regarding the end user's preferences, just as with the content profile, such as preferred subject(s) 504 (e.g., sports), with a subsequent preferences as to his favorite sport(s) 606 (e.g., baseball, basketball, hockey, football, etc.), favorite league(s) 608, favorite sports team(s) 610, and so on. The user profile 502 may also include a rank or degree of preferability as to what categories are more important over others to the end user (e.g., baseball is preferred over hockey, hockey over soccer, etc.). For example, instead of assigning only a ‘1’ or a ‘0’ to each category to indicate a like or dislike, the user profile 502 may associate a scaling value with each category, which indicates the degree to which the end user likes a particular category or the degree to which the end user places importance on a particular category. The degree to which an end user prefers a particular category may be used in the selection of content components to be included in the assembled publication and/or the placement of the content components in the publication. For example, content components having a subject primarily preferred by the end user over other subjects may be placed near the beginning of the publication.

Alternatively, the selector 26 may be able to determine a degree of match between each content component and the end user's preferences by comparing the content profile and user profile 502 to see how often a match occurs in each category. The selector 26 may then rank the content components accordingly to reflect the end user's preferences, where content components having the most matches among the different categories are placed near the beginning of the publication and content components with the least number of matches among the different categories are placed near the end or excluded altogether.

Regardless of the categories used and the level of detail involved, it is preferred that the user profile 502 be formatted in the same manner as the content profile and that each profile have some commonly defined characteristic categories (e.g., the same subject matter categories, the same age categories, etc.). For example, the user profile of FIG. 8 is a data key that uses bits to represent the user's likes (‘1’) and dislikes (‘0’) regarding subject matter as well as some of the user's demographic information (i.e., age and gender). This format corresponds directly with the data key 102 used to act as a content profile to describe the characteristics of a content component as seen in FIG. 3.

However, it is possible that either the content profile or the user profile may go into different degrees of detail in describing their respective characteristics. For example, the user profile may define both the sport and sports teams that the user prefers, whereas the content profile may only go so far as to define the sports contained in a content profile without going into detail about what teams are involved. Provided the end user is interested in sports, the content component relating to sports may be considered by the selector 26 to be of general interest to the end user and thereby drive its inclusion into the assembled publication even though there is no detail regarding what sports team the content component may relate to. As long as there is some minimum correspondence between the categories of the content profile and the categories of the user profile 502, there can at least be some minimal determination of whether the end user may be interested in the content component or not to cause the content component to be selected or not. Therefore, absolute correspondence is not necessarily required.

Personalized information regarding the end user may be stored in the database 24 and matched with relevant corresponding information in the broadcast. For example, the personalized information may include information on all the stocks, bonds, etc. that the end user owns including the type and quantity. Typically, stocks are associated with a particular stock symbol for identification purposes. The content profile may include information on this identification which, if the stock belongs to the end user, the selector 26 may recognize and specially store or copy. Other methods of specially recognizing and selecting content components as being particularly relevant to the end user may include keywords included in the content profile which may be searched by the selector 26 and compared against keywords associated with the user profile. For example, if a content component is an article about company ‘ABC, Inc.’ a list of keywords associated with that content component would include the company name ‘ABC, Inc.’ If the end user has a special interest in ABC, Inc. (e.g., a stock investment in the company), the keyword ‘ABC, Inc.’ can be stored and searched by the selector 26. Any content component that is associated with the keyword ‘ABC, Inc.’ is specially identified by the selector 26 and presented to the end user. The degree to which an end user is interested in the content component or the degree to which the content component is relevant to personalized information can also be associated with the keyword. For example, if the end user has a lesser degree of interest in ABC, Inc. products but still a high degree of interest in ABC, Inc. stock information, the keywords may include ‘stock’ and ‘product’ in the keyword list with a scaling value associated with each keyword to indicate the end user's preference for ABC, Inc. stock information but not for ABC, Inc. product information. Likewise, if ABC, Inc. product information is less relevant to the end user's personalized information than ABC, Inc. stock information, the scaling values may reflect this. In selecting content components, the selector 26 may not only take into account the end user's preferences and interests, but also the end user's personalized information and overall relevance of the content component.

As mentioned above, the receiver 408 may receive the datastream carrying the publication over one or more channels. There may also be several publications that are broadcast over several channels at the same or a different time. If the receiver 408 only includes one tuner 22, it can generally only monitor one channel at a time, and hence download only one publication at a time. Alternatively, the receiver 408 may include multiple tuners to receive multiple channels concurrently, or a single tuner that may receive multiplexed signals. Furthermore, the end user may subscribe to several publications or the receiver 408 may receive several publications for several different end users. Each publication may be received on a different channel at different times. Therefore, the receiver 408 requires a schedule in order to determine what channel to tune to and when to tune to that channel so as to receive the publication.

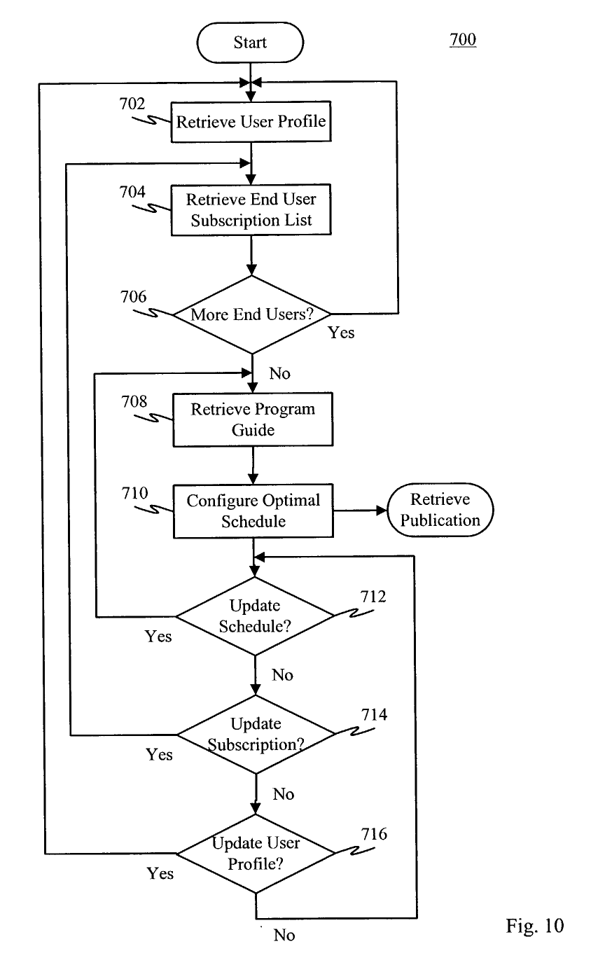

In order to determine the optimal schedule for downloading the publications, the scheduler 30, which may be implemented in or coupled to the receiver 408, includes a scheduling routine 700, as shown in FIG. 10. Beginning at block 702, the scheduler 30 retrieves the user profile for the end user. The scheduler 30 further retrieves a list of each publication that the end user subscribes to or is otherwise authorized to receive at block 704. At block 706, the scheduler 30 checks to see if there are more end users for whom the receiver 408 is to receive publications. If there are more end users, the scheduler 30 retrieves their user profiles and subscription lists accordingly. Otherwise the scheduler 30 continues to block 708, where the scheduler 30 accesses a program guide which details when the content provider is expected to broadcast the content components for a particular publication. This program guide may be made available on a database for the receiver 408 to call up via the phone line 410 or via a return channel on the broadcast system. Alternatively, the program guide may be periodically broadcast over one or more channels as part of the datastream. The program guide details when a publication is to be broadcast and on what channel, and may give programming information about all publications on all channels or may relate only to those publications on a particular channel. The program guide may further be displayed to the end user and allow selection of publications through onscreen programming.

In one example, each channel that carries publications may broadcast its own program guide containing information about only the publications on that channel and the times of broadcast. The scheduler 30 may cooperate with the tuner 22 to retrieve or update the program guide from each channel at a particular time. The scheduler 30 may then combine the various program guides into one master program guide that may be updated or modified periodically by the scheduler 30.

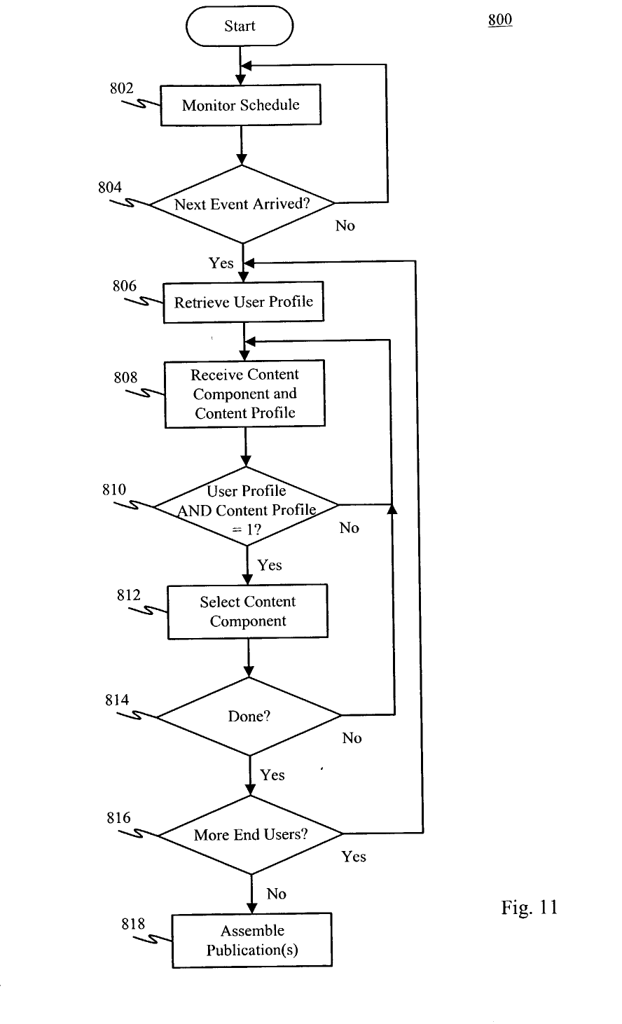

The scheduler 30 monitors the program guide(s) to determine when and to what channel a publication listed on the end user's subscription list is to be broadcast and schedules itself to tune to that channel at the designated time to receive the publication. Once the scheduler 30 has performed this operation for each subscription it is to receive, at block 710 the scheduler 30 creates an optimal schedule for which to retrieve each publication. In the case of a scheduling conflict, the scheduler 30 may contain information, either developed empirically or via the end user's input, as to the end user's preferences for each subscribed publication. The scheduler 30 will then make a choice as to which publication it will download based on those priorities. Alternatively, a publication may be broadcast at several different times and/or on several different channels thereby providing the scheduler 30 with more options for when to schedule the download. Once the scheduler 30 has created the schedule, it proceeds to a retrieval routine shown in FIG. 11 and described below.

In addition to creating a schedule, the scheduler 30 may further determine if the schedule should be updated or modified at block 712. The scheduler 30 routinely updates the program guide to look for new publications that are made available or to monitor any changes in the scheduled broadcast of a publication. The scheduler 30 may perform these updates every few minutes, once a day, when the end user is typically away or at any desired frequency, the occurrence of which may be determined by the end user. If the scheduler 30 determines that an update should be made to the schedule, the routine will return to block 708 to receive the program guide to check for any updates and revise the schedule accordingly at block 710. The scheduler 30 may further dynamically adjust to various situations, such as if the media device 414 or receiver 408 is out of the area, the receiver 408 is turned off, the receiving database/buffer is full, etc. The scheduler 30 may therefore automatically request (or re-request) publications it was unable to download, cause existing publications to be overwritten with new issues (or versions) of the same subscription or delete the publication entirely if the information in the publication is outdated (e.g., last week's newspaper).

In order to retrieve new or specially requested publications, the scheduler 30 determines if there are any new publication or subscription requests at block 714. The new publications may include new subscriptions, single issues, revisions to old subscriptions, such as renewal or cancellation, or other modifications to an existing subscription. The update may also include special requests for a publication, such as an electronic book, a back issue of a periodical publication, or any other electronic publication. The scheduler 30 may further send information over a return channel, phone line, etc. so as to order a specific publication at a certain time, thereby allowing the scheduler 30 or end user to dictate when the publication is to be delivered and avoid conflicts with other downloads.

Generally, new publications and issues of periodical publications may be routinely broadcast at certain times and/or on certain channels, much like television programs, to provide a degree of certainty as to when the tuner 22 should download a new publication or the latest issue of a periodical publication. However, after a predetermined amount of time, or when a new issue becomes available, the publication may be placed in an archives database to be broadcast only when there is a special request for that publication to save bandwidth on the broadcast channels. The end user may make the request to the content provider over the phone, Internet, via a return channel on the broadcast signal or via the media device 414. The request would be provided to the tuner 22 along with any authorization codes needed to download the publication from the datastream. The scheduler 30 then updates the subscription list at block 704 to include the request and search for the publication on the program guide. Alternatively, the request may be accompanied by a specified download time and channel as provided by the content provider or custodian of the archives database. In yet another example, the program schedule may include a predetermined time and channel for which to download any specially requested publications.

In order to learn and grow with the end user's reading habits, the scheduler 30 may determine if there have been any changes in the end user's reading habits, preferences, etc. at block 716. The scheduler 30 determines if there are any changes based on input from the end user or from monitoring the end user's reading habits. If there are any changes to be made to the user profile, the scheduler 30 and/or database 24 updates the user profile accordingly and further updates the subscription list, download schedule, etc. as needed based on the changes to the user profile. To download a publication, determine if a content component is to be included in the assembled publication, and to further assemble the publication in a manner customized to the end user's preferences, the selector 26 and/or the assembler 28, which may be implemented in or coupled to the receiver 408, includes an assembly routine 800 for analyzing each content component and content profile to determine if the content component is compatible with the end user's preferences. FIG. 11 is a flow chart of an example of a download and assembly routine 800 that the illustrated selector 26 and/or assembler 28 perform to receive the datastream and assemble the publication. Once a downloading schedule has been created from the scheduling routine 700, the download and assembly routine 800 monitors the schedule at block 802 and determines whether or not a download “event” has occurred or is about to occur at block 804. An event may be defined as the download time or a time just prior to the scheduled download of a new publication, an update to an existing publication, etc. If the event has not occurred, the assembly routine 800 continues to monitor the program guide and look for the time and channel of the next scheduled download.

If a download event occurs or is about to occur, the tuner 22 tunes to the appropriate channel, if necessary, in preparation for receiving the publication and the selector 26 retrieves the user profile at block 806. The datastream is received at the tuner 22 and includes each of the content components that may be used in assembling the publication, the content profiles of each content component and the layout description for the publication. The tuner 22 may temporarily store the entire datastream of the publication in the database 24 during the customization and assembly, or the selector 26 may analyze each set of content components and content profiles in the datastream as they are downloaded, saving only those that will be included in the assembled publication.

The tuner 22 receives a content component and its associated content profile at block 808 in order to perform a comparison between the user profile and the content profile. The order in which the assembly routine 800 considers each content component may based on the layout description 300 in which the selector 26 analyzes the first content component listed in the first area of the layout description 300, then any second content component in the first area and so on until either the requisite number of content components for a given area has been fulfilled or there are no further content components to consider for that area. Then the assembly routine 800 may consider the content components listed in the next given area 302. If there are multiple end users to be considered (e.g., members of a household), the assembly routine may check to see if there is a priority of distribution, such that one end user is to receive his version before another end user.

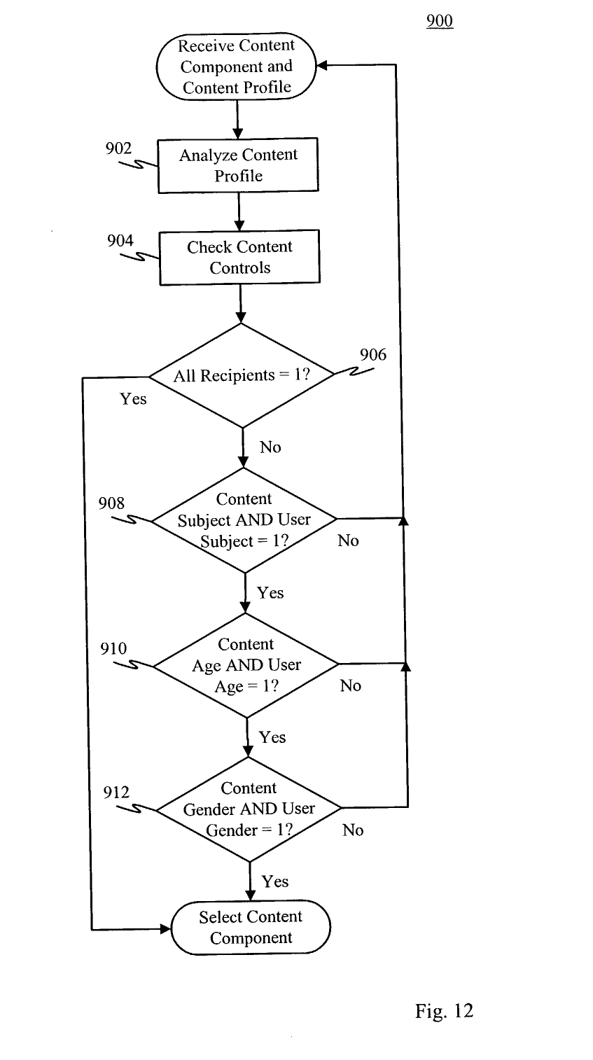

The comparison is performed at block 810 where the assembly routine 800 compares the attributes of the content component to the preferences in the user profile. An example of the comparison procedure is discussed more fully below with respect to FIG. 12. The comparison 810 is performed for each content component to determine whether or not the content component is to be included in the assembled publication. The comparison 810 may also be used to determine where the content component will be placed or otherwise how the content component will be included in the assembled publication. As described above, the content profile and the user profile are in substantially the same format where corresponding bit(s) signify whether or not a content component is compatible with the user's preferences. Therefore, the comparison 810 may simply be a determination of whether a logical “AND” operation between the corresponding bit(s) of the user profile and the content profile results in a non-zero result. If yes, it means that the content component has attributes that are compatible with the user's preferences (e.g., the article is about sports and the end user likes sports), and the content component is selected to be included in the assembled publication at block 812. If the result is not a non-zero result (e.g., the content component and user preferences are not compatible), the assembly routine 800 returns back to block 808 to retrieve the next content component and content profile in the datastream.

While the comparison at block 810 has been described as a simple logical “AND” operation, the comparison 810 may be one of degree where the routine performs the comparison to determine to what extent the end user would prefer having the content component included in the assembled publication as opposed to completely excluding the content component if there is not a perfect match. The assembled publication may reflect these preferences by placing or organizing more preferred content components in a manner different from the placement and organization of less preferred content components (e.g., more preferred content components are placed towards the beginning of the publication). Least preferred content components may be excluded altogether, unless overridden by the content provider preferences.

A more detailed view of an example of the comparison process 810 is shown in FIG. 12 as a comparison routine 900, which may be performed by the selector 26. As seen in FIG. 12, once the scheduler 26 has received a content component and its content profile, the content profile is analyzed at block 902. The comparison routine 900 checks the content controls at block 904 to determine if there are any overriding content provider preferences. For example, the comparison routine 900 may check to see if the “All Recipients” bit is set to “1,” which, as described above, may be used by the content provider to override the end user's preferences. However, other content provider preferences which drive the inclusion of the content component into the assembled publication may also be considered at block 906. For example, fixed data would be included in the assembled publication regardless of the end user's preferences, though the end user's preferences may optionally affect how the fixed data is presented. As a further example, according to the layout description 300 in FIG. 5, the second area is only associated with one content component (i.e., Editorial1). Thus, the second area must include Editorial1 regardless of the end user's preferences. Customized or personalized information may also be driven into the assembled publication based on specific identification of the end user (e.g., the “User ID”).

If there are no overriding content provider preferences, the comparison routine 900 compares the various categories such as subject, age, gender, etc. in the content profile that describe attributes of the content component with corresponding categories in the user profile. For example, at block 908 the comparison routine 900 compares the subject of the content component with the subject preferences described in the user profile. If there is no match between the subject of the content component and the subject preferences of the user, the selector 26 receives the next content component and content profile for comparison. If the subject preferences match, then the comparison routine 900 continues to check the age category at block 910 and gender category at block 912, or any other category that may be used to describe the content component and/or the user preferences. If there is a lack of a match in any category, the selector 26 receives the next content component for comparison. If there is a match between the content profile categories and the user profile categories, then the content component is selected. However, as mentioned above, the comparison may not result in an absolute inclusion or exclusion of the content component, but may rather result in a degree of match. Each category comparison may also include several levels of comparisons because each category may include several levels of detail as shown in FIGS. 4 and 9. Furthermore, the comparison routine 900 may compare each category to determine an overall compatibility before deciding whether to include or exclude the content component. In addition, each category may be weighted more than others, such that if there is a match in one category, a mismatch in other categories is partially or completely offset. The comparison routine may also analyze keywords associated with the content component, wherein the assembly routine 800 consistently searches for keywords that are associated with the end user's preferences and the comparison routine 900 determines how closely they relate to the end user's preferences.

Referring again to FIG. 11, once a content component is selected for an end user's publication at block 812, the assembly routine 800 checks whether there are any further content components for consideration at block 814. If so, the assembly routine 800 receives the next content component and content profile. If not, the assembly routine 800 may check at block 816 to see if there are any other end users (e.g., within the same household) that also subscribe to the same publication. If there are more end users, the assembly routine 800 proceeds to retrieve the next user profile and perform a comparison 810 between all the content profiles and the new user profile. If there is any overlap between those content components selected for the first end user and those content component selected for the second end user, the selector 26 may only store one version of the overlapping content components so as to save space in the database.

When a content component has been selected, the publication can begin to be assembled in accordance with the layout description at block 818. The publication may be assembled into a device-specific format such as viewing formats for a personal digital assistant, computer monitor, etc. using a formatting language such as XSLT. The assembly 818 of the publication is generally done in accordance with the layout description 300 discussed with reference to FIG. 5. For example, once the content components of a given area 302 have been selected, the assembly procedure 818 may further refine the selection based on the content provider preferences. In the case of area four, only three advertisements are needed. The number of content components selected from the comparison 810 for area four may exceed the number of content components needed (e.g., four content components for area four are compatible with the end user preferences, but only three are needed). Therefore, the assembly routine 800 may further select the content components from those content components that were found to be compatible with the end user's preferences. This second selection may be based on the content provider's preferences by reading the layout description 300 and determining from the order in which the content components are listed, which content components the content provider prefers. In another example, the publication may be assembled from only the content components selected based on the user's preferences where the assembly is performed according to the content provider's preferences as reflected in the layout description.

Upon fulfilling a given area, completing assembly of a page or assembling the publication, the assembly routine 800 may further insert filler material as needed to avoid excess space in the publication. The assembly 818 may also combine content components for a given area. For example, an article on baseball may be combined with a content component representing a background with a sports theme. Both of these content components may be displayed together in the same area with the article in the forefront having a sports-themed background. Both the article and the background may be chosen based on the end user's preferences.

The assembly 818 of the publication may further take into account other preferences of either the content provider and/or the end user as to other aspects of the publication such as font attributes, the size of each content component, coloring, etc. Personalized information may also be taken into account and given special formatting and assembly. For example, one or more content components relating to stock market information containing the daily activity of all stocks in that particular stock market may be filtered to highlight only those stocks owned by the end user. Upon reading the content profile of a content components, the assembly routine 800 may identify those stocks owned by the end user. The assembly 818 may specially analyze, format and include this information on a separate page containing all personalized end user information. This information may also be analyzed, formatted and presented as graphs or charts of the stocks'performance, or any of a number of presentation options.

In addition, the assembly 818 may involve updating an existing publication. For example, the end user may already have a copy of a publication which may be updated on a regular basis, such as with a new edition of an electronic book, magazine, newspaper, etc. The tuner 22 may therefore only receive those content components that are considered new and meant to be added to the publication or to replace existing content components.

Once the publication has been assembled, it may be stored in the database 24 for a certain period of time, until the end user views the publication or downloads the publication or until the publication (or merely sections thereof) is overwritten based on downloaded updates. The assembler 28 may therefore be provided with a communication port 32, which may be infrared, hardwire, radio transmission, Bluetooth or any other method of data communication to download the assembled publication to the media device 414 being used by the end user. The assembled publication may be automatically downloaded to the media device without intervention by the end user. As mentioned, the publication is generally assembled in accordance with the media device 414 format, which may be programmed into the assembler 28 prior to receiving and assembling the publication.

While the scheduling routine 700, assembly routine 800 and comparison routine 900 have been described as being stored on the receiver 408, the routines 700, 800, 900 are not limited thereto. The routines 700, 800, 900 may be included on any medium that is communicatively coupled to the receiver 408 that will control or otherwise cause the receiver 408 to receive and assemble the publication as described above. For example, as mentioned above the receiver 408 may simply be a conventional digital video recorder, in which case an exterior module may be coupled to the digital video recorder and run the routines 700, 800, 900 to control the digital video recorder.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method of delivering an electronic publication to a receiving user via a broadcast communication system, the method comprising:
receiving a plurality of content components and content provider preferences at a receiver;
selecting at least one of the content components from the plurality of content components based upon user preferences to provide a first selection of content components, the user preferences being predefined by the receiving user;
selecting at least one of the content components from the first selection of content components based upon the content provider preferences to provide a second selection of content components; and
assembling the publication from at least the second selection of content components to create an assembled publication.

2. A method as defined in claim 1, further comprising receiving a layout description of the publication at the receiver.

3. A method as defined in claim 2, wherein the layout description comprises at least one of the content provider preferences and at least one of the content components.

4. A method as defined in claim 2, wherein assembling the publication is performed in accordance with the layout description.

5. A method as defined in claim 1, wherein the user preferences include preferences as to the arrangement of content components in the publication.

6. A method as defined in claim 1, wherein the content provider preferences include preferences as to the arrangement of content components in the publication.

7. A method as defined in claim 1, further comprising:
assigning a content profile to each of the content components, the content profile including data representative of characteristics of the content component to which the content profile is assigned; and
transmitting the content profiles with the content components to the receiver.

8. A method as defined in claim 7, wherein selecting at least one of the content components based upon user preferences comprises comparing the content profile of each of the plurality of content components to the user preferences.

9. A method as defined in claim 1, further comprising transferring the assembled publication to a media device, wherein assembling the publication is done in accordance with formatting requirements of the media device.

10. A method as defined in claim 1, wherein the content components and the content provider preferences are received via a broadcast channel as a first set of content components and content provider preferences.

11. A method as defined in claim 10, further comprising:
scheduling retrieval of the first set of content components and content provider preferences from the first broadcast channel during a first time period; and
tuning to the first broadcast channel at a first time prior to the first time period;
wherein receiving a plurality of content components and content provider preferences at a receiver comprises receiving the first set of content components at the receiver during the first time period.

12. A method as defined in claim 11, further comprising:
scheduling retrieval of a second set of content components and content provider preferences; and
receiving the second set of content components and content provider preferences at the receiver.

13. A method as defined in claim 12, wherein the second set of content components and content provider preferences is retrieved from a second broadcast channel, the method further comprising tuning to the second broadcast channel.

14. A method as defined in claim 13, wherein:
the second set of content components and content provider preferences is scheduled to be retrieved at a second time period different from the first time period;
tuning to the second broadcast channel is performed at a second time different from the first time and prior to the second time period; and
the second set of content components and content provider preferences is received at the receiver during the second time period.

15. A method as defined in claim 12, wherein the second set of content components and content provider preferences is scheduled to be retrieved during at least part of the first time period.

16. A method as defined in claim 12, wherein the second set of content components and content provider preferences is retrieved from the first broadcast channel.

17. The method as defined in claim 16, wherein the second set of content components and content provider preferences is retrieved during a time period different than the first time period.

18. The method as defined in claim 16, wherein the first set of content components and content provider preferences is multiplexed with the second set of content components and content provider preferences, and the second set of content components and content provider preferences is retrieved during at least part-of the first time period.

19. A method as defined in claim 1, further comprising updating the assembled publication with at least one content component and content provider preference.

20. A method as defined in claim 1, wherein the content provider preferences are used to prioritize the arrangement of the content components in the publication.

21. The method as defined in claim 1, wherein the content components comprise at least one of an editorial, an article, an advertisement and a picture.

22. A method of delivering an electronic publication to a receiving user via a broadcast communication system, the method comprising:
receiving a plurality of content components and content provider preferences at a receiver, the content provider preferences including preferences as to the arrangement of content components in the publication;
selecting at least one of the content components from the plurality of content components based upon user preferences to provide a first selection of content components, the user preferences being predefined by the receiving user; and
assembling the publication from one or more of the content components of the first selection of content components in accordance with the content provider preferences to create an assembled publication.

23. A method as defined in claim 22, further comprising receiving a layout description of the publication at the receiver.

24. A method as defined in claim 23, wherein the layout description comprises at least one of the content provider preferences and at least one of the content components.

25. A method as defined in claim 23, wherein assembling the publication is performed in accordance with the layout description.

26. A method as defined in claim 22, wherein the user preferences include preferences as to the arrangement of content components in the publication.

27. A method as defined in claim 22, further comprising:
selecting at least one of the content components from the first selection of content components based upon the content provider preferences to provide a second selection of content components,
wherein the publication is assembled from the second selection of content components.

28. A method as defined in claim 22, further comprising:
assigning a content profile to each of the content components, the content profile including data representative of characteristics of the content component to which the content profile is assigned; and
transmitting the content profiles with the content components to the receiver.

29. A method as defined in claim 28, wherein selecting at least one of the content components based upon user preferences comprises comparing the content profile of each content component to the user preferences.

30. A method as defined in claim 22, further comprising transferring the assembled publication to a media device, wherein assembling the publication is done in accordance with formatting requirements of the media device.

31. A method as defined in claim 22, wherein the content components and the content provider preferences are received via a broadcast channel as a first set of content components and content provider preferences.

32. A method as defined in claim 31, further comprising:
scheduling retrieval of the first set of content components and content provider preferences from the first broadcast channel during a first time period; and
tuning to the first broadcast channel at a first time prior to the first time period wherein receiving a plurality of content components and content provided preferences at a receiver comprises receiving the first set of content components and content provider preferences at the receiver during the first time period.

33. A method as defined in claim 32, further comprising:
scheduling retrieval of a second set of content components and content provider preferences; and
receiving the second set of content components and content provider preferences at the receiver.

34. A method as defined in claim 33, wherein the second set of content components and content provider preferences is retrieved from a second broadcast channel, the method further comprising tuning to the second broadcast channel.

35. A method as defined in claim 34, wherein:
the second set of content components and content provider preferences is scheduled to be retrieved at a second time period different from the first time period;
tuning to the second broadcast channel is performed at a second time different from the first time and prior to the second time period; and
the second set of content components and content provider preferences is received at the receiver during the second time period.

36. A method as defined in claim 34, wherein the second set of content components and content provider preferences is scheduled to be retrieved during at least part of the first time period.

37. A method as defined in claim 33, wherein the second set of content components and content provider preferences is retrieved from the first broadcast channel.

38. The method as defined in claim 37, wherein the second set of content components and content provider preferences is retrieved during a time period different than the first time period.

39. The method as defined in claim 37, wherein the first set of content components and content provider preferences is multiplexed with the second set of content components and content provider preferences, and the second set of content components and content provider preferences is retrieved during at least part of the first time period.

40. A method as defined in claim 22, further comprising updating the assembled publication with at least one content component and content provider preferences.

41. A method as defined in claim 22, wherein the content provider preferences are used to prioritize the arrangement of the content components in the publication.

42. The method as defined in claim 22, wherein content components are at least one of an editorial, an article, an advertisement and a picture.

43. An apparatus for retrieving a publication from a first broadcast datastream transmitted via a first broadcast channel, the first broadcast datastream containing a plurality of content components and content provider preferences, the apparatus comprising:
a tuner arranged to tune to the first broadcast channel to receive the first broadcast datastream;
a database containing information about a user;
a content component selector cooperating with the database to select at least one content component from the plurality of content components to produce a first selection of content components based at least in part on the information about the user; and
an assembler cooperating with the content component selector and the database to assemble the publication based at least in part on the information about the user and at least in part on the content provider preferences.

44. An apparatus as defined in claim 43, wherein the assembler assembles the publication from at least the first selection of content components.

45. An apparatus as defined in claim 43, wherein:
the content component selector cooperates with the database to select at least one content component from the plurality of content components to produce a second selection of content components based at least in part on the content provider preferences, and
the assembler assembles the publication from at least the first and second selection of content components.

46. An apparatus as defined in claim 43, wherein:
the content component,selector cooperates with the database to select at least one content component from the first selection of content components to produce a second selection of content components based at least in part on the content provider preferences, and
the assembler assembles the publication from at least the second selection of content components.

47. An apparatus as defined in claim 43, wherein the first broadcast datastream further contains a layout description and the assembler assembles the publication in accordance with the layout description.

48. An apparatus as defined in claim 43, wherein the first broadcast datastream further contains at least one content profile that includes data representative of characteristics of the content component to which the content profile is assigned, wherein the content component selector selects at least one content component by comparing the content profile of each content component to the information about the user.

49. An apparatus as defined in claim 43, wherein the information about the user comprises preferences of the user as to at least one of the selection of the content components and the arrangement of the content components.

50. An apparatus as defined in claim 43, further comprising a communication port to communicate with an external media device.

51. An apparatus as defined in claim 50, wherein the assembler assembles the publication in accordance with formatting requirements of the external media device.

52. An apparatus as defined in claim 43, further comprising:
a scheduler arranged to schedule the retrieval of the first broadcast datastream from the first broadcast channel; wherein the tuner cooperates with the scheduler to tune to the first broadcast channel at a first time to receive the first broadcast datastream.

53. An apparatus as defined in claim 52, wherein the scheduler is further arranged to schedule the retrieval of a publication from a second broadcast datastream transmitted via a second broadcast channel, the second broadcast datastream containing a second plurality of content components and content provider preferences, wherein the tuner cooperates with the scheduler to tune to the second broadcast channel to receive the second broadcast datastream.

54. An apparatus as defined in claim 53, wherein the tuner comprises a first tuner to receive the first datastream and a second tuner to receive the second datastream, wherein at least part of the first datastream and at least part of the second datastream are received at the same time.
